(19) United States
(12) Patent Application Publication
(10) Pub. No.: US 2024/0192578 A1
(43) Pub. Date: Jun. 13, 2024

(54) PROJECTOR AND PROJECTION SYSTEM

(71) Applicant: ams-OSRAM International GmbH, Regensburg (DE)

(72) Inventors: Jörg Erich SORG, Regensburg (DE); Tilman RÜGHEIMER, Regensburg (DE); Christoph WALTER, Regensburg (DE)

(21) Appl. No.: 18/286,875

(22) PCT Filed: Apr. 12, 2022
(86) PCT No.: PCT/EP2022/059748

§ 371 Date: Oct. 13, 2023

(30) Foreign Application Priority Data
Apr. 16, 2021 (DE) 10 2021 109 640.5

(51) Int. Cl. G03B 21/20; G03B 21/00

(52) U.S. Cl. CPC G03B 21/2013; G03B 21/006; G03B 21/204; G03B 21/2053; G03B 21/2066; G03B 21/208

(57) ABSTRACT

A projector includes a first optoelectronic semiconductor chip for generating a first radiation having a first color. The projector also includes a second optoelectronic semiconductor chip for generating a second radiation-having a second color. The projector further includes a wavelength conversion element which is configured to generate a third radiation having a third color from a first portion of the first radiation. The projector additionally includes beam splitter. The projector also includes a scattering plate. The wavelength conversion element is configured to fully convert the first portion of the first radiation. The beam splitter is configured to branch off a second portion of the first radiation upstream of the wavelength conversion element. The scattering plate is arranged in a beam path of the second portion of the first radiation at a point at which the first portion has already been branched off.

A projector is specified. In addition, a projection system is specified.

An object to be solved is to specify a projector that can be operated efficiently.

This object is solved, inter alia, by a projector and by a projection system having the features of the independent patent claims. Preferred further embodiments are the subject of the dependent claims.

According to at least one embodiment, the projector comprises one or more first optoelectronic semiconductor chips. The at least one first optoelectronic semiconductor chip is configured to generate a first radiation having a first color. In particular, the first color is blue, such that the first radiation is blue light. The at least one first optoelectronic semiconductor chip is preferably a laser diode, however, the at least one first optoelectronic semiconductor chip may also be a light emitting diode, LED for short, or a superluminescent light emitting diode, S-LED for short. Examples of possible laser diodes are VCSELs, that is, Vertical Cavity Surface Emitting Lasers, or HCSELs, that is, Horizontal Cavity Surface Emitting Lasers. The term vertical refers to a cavity parallel to a growth direction of a semiconductor layer sequence of the laser diode and the term horizontal refers to a cavity perpendicular to the growth direction, and surface emitting means in particular that the radiation is emitted parallel to the growth direction.

According to at least one embodiment, the projector comprises one or more second optoelectronic semiconductor chips. The at least one second optoelectronic semiconductor chip is configured to generate a second radiation having a second color. In particular, the second color is red, such that the second radiation is red light. The at least one second optoelectronic semiconductor chip is preferably also a laser diode, such as a VCSEL or a HCSEL, however, the at least one second optoelectronic semiconductor chip may also be an LED or S-LED.

According to at least one embodiment, the projector comprises one or more wavelength conversion elements, in particular exactly one wavelength conversion element. The wavelength conversion element is configured to generate a third radiation having a third color. In particular, the third color is green, such that the third radiation is green light.

According to at least one embodiment, the wavelength conversion element generates the third radiation from a first portion of the first radiation. In particular, a full conversion of the first portion into the third radiation takes place in the wavelength conversion element, although a partial conversion is also possible.

According to at least one embodiment, the wavelength conversion element comprises at least one phosphor selected from the group consisting of: garnets from the general system (Gd,Lu,Tb,Y)₃(Al,Ga,D)₅(O,X)₁₂:RE where X=halide, N or divalent element, D=trivalent or tetravalent element, and RE=rare earth metals, such as Lu₃(Al₁₋ₓGaₓ)₅O₁₂:Ce³⁺, Y₃(Al₁₋ₓGaₓ)₅O₁₂:Ce³⁺; SiAlONs, for example, from the system LiₓM_{y}Ln_{z}Si₁₂₋₍ₘ₊ₙ₎Al₍ₘ₊ₙ₎OₙN₁₆₋ₙ; beta-SiAlONs from the system Si₆₋ₓAl_{z}O_{y}N_{8-y}:RE_{z} with RE=rare earth metals; nitrido-orthosilicates, such as AE₂₋ₓ₋ₐREₓEuₐSiO₄₋ₓNₓ or AE₂₋ₓ₋ₐREₓEuₐSi_{1-y}O_{4-x-2y}Nₓ with RE=rare earth metal and AE=alkaline earth metal or such as (Ba,Sr,Ca,Mg)₂SiO₄:Eu²⁺. BAM phosphors from the BaO—MgO—Al₂O₃ system, such as BaMgAl₁₀O₁₇:Eu²⁺; halophosphates, such as M₅(PO₄)₃(Cl,F):(Eu²⁺,Sb²⁺,Mn²⁺); KSF phosphors based on potassium, silicon and fluorine, such as K₂SiF₆:Mn⁴⁺, Alternatively or additionally, so-called quantum dots can be introduced as converter material in the wavelength conversion element. Quantum dots in the form of nanocrystalline materials containing a group II-VI compound and/or a group III-V compound and/or a group IV-VI compound and/or metal nanocrystals are preferred here. Furthermore, the wavelength conversion element may have a quantum well structure and thus may be at least partially epitaxially grown.

According to at least one embodiment, the at least one first and/or the at least one second optoelectronic semiconductor chip each comprises a semiconductor layer sequence. The semiconductor layer sequences each comprise at least one active zone, which is configured to generate the first or second radiation during operation. The generated radiation is preferably coherent. The semiconductor layer sequences are preferably each based on a III-V compound semiconductor material. For example, the semiconductor materials are a nitride compound semiconductor material such as AlₙIn₁₋ₙ₋ₘGaₘN or a phosphide compound semiconductor material such as AlₙIn₁₋ₙ₋ₘGaₘP or also an arsenide compound semiconductor material such as AlₙIn₁₋ₙ₋ₘGaₘAs or such as AlₙGaₘIn₁₋ₙ₋ₘAsₖP₁₋ₖ, where in each case 0≤n≤1, 0≤m≤1 and n+m≤1 as well as 0≤k<1. Preferably, for at least one layer or for all layers of the semiconductor layer sequence, 0<n≤0.8, 0.4≤m<1 and n+m≤0.95 as well as 0<k≤0.5. In this context, the semiconductor layer sequences may have dopants as well as additional components.

For the sake of simplicity, however, only the essential constituents of the crystal lattice of the semiconductor layer sequences, that is, Al, As, Ga, In, N or P, are mentioned, even if these may in some cases be replaced and/or supplemented by small amounts of further substances.

Preferably, the semiconductor layer sequence of the at least one first optoelectronic semiconductor chip is based on the material system AlₙIn₁₋ₙ₋ₘGaₘN and the semiconductor layer sequence of the at least one second optoelectronic semiconductor chip is based on the material system AlₙIn₁₋ₙ₋ₘGaₘP.

In at least one embodiment, the projector comprises a first semiconductor optoelectronic chip for generating a first radiation having a first color, a second semiconductor optoelectronic chip for generating a second radiation having a second color. Further, the projector comprises a wavelength conversion element configured to generate a third radiation having a third color from a first portion of the first radiation. Optionally, the projector further comprises a beam splitter and a scattering plate, wherein the wavelength conversion element is configured to fully convert the first portion of the first radiation, the beam splitter is configured to branch off a second portion of the first radiation before the wavelength conversion element, and the scattering plate is disposed in the beam path of the second portion of the first radiation at a location where the first portion is already branched off.

The concept described here aims to improve the efficiency of projection systems pumped with semiconductor lasers, for example, while at the same time improving color reproduction.

In particular, the concept described here addresses the following two points:
By selectively adding light from another laser light source, in particular a red-emitting laser, the red light required for displaying an image is generated directly. Other projectors, on the other hand, filter out the red light from a long-wavelength flank of a fluorescent spectrum with a maximum in the yellow or green spectral range. To generate comparatively little red light, a lot of short-wavelength pump radiation must be used for this purpose.
A spectrally broad long-wavelength spur of the phosphor emission usually extends into the non-visible near-infrared spectral range. This spur requires a lot of energy for its generation, but does not contribute to color representation and image brightness.

In conventional projectors, HID lamps, that is, high-intensity discharge lamps, are usually used as the light source. These lamps are inexpensive and combine the advantages of high luminance, also known as luminous flux, and high efficiency with a wide emission spectrum. The wide emission spectrum can be used to achieve good color rendering of the projector. A disadvantage is the only short lifetime of such HID lamps. After an operating time of only about 1500 hours to 2000 hours, significant loss of brightness or even total failure occurs. HID lamps must therefore be replaced regularly.

In recent years, semiconductor lasers have made great progress in terms of their brightness, their efficiency and their cost. With semiconductor lasers, lifetimes on the order of 20,000 to 30,000 operating hours are possible. A major problem of HID-based projectors, that is, the short life of HID lamps, can thus be eliminated. Against this background, there are efforts to replace HID lamps in projection systems with semiconductor lasers as the light source.

The semiconductor lasers that can be used to replace the HID lamps preferably have a blue, spectrally very narrow-band emission, for example, with a spectral width of about 2 nm. The wavelengths typically used are in the range of 445 nm to 465 nm. However, blue light is not sufficient to display the entire color space. Therefore, phosphors are excited with the blue pump wavelength in order to obtain further wavelengths for the images to be displayed.

By pumping the phosphors with lasers, very high energy densities occur at the phosphor; such systems, in which a laser pumps a phosphor, are also called Laser-Activated Remote Phosphor, or LARP for short. The choice of phosphors known and suitable for this purpose is severely limited, or for some applications no suitable red-emitting phosphor materials are available or known. Red emitting phosphor materials reach their limits very quickly at the power densities commonly used for LARP due to self-heating as a result of the Stokes shift that occurs, accompanied by so-called temperature quenching, and due to the high power density in the optical flow, that is, so-called power quenching. In addition, phosphors with emission in the red spectral range usually also emit in the non-visible, long-wavelength range. To handle these difficulties, two solutions in particular are conceivable: The use of spectrally broadband green emitting phosphors and filtering out the red light from the long-wavelength tail of the emission spectrum, or the use of red emitters, that is, in particular a light source directly generating red light.

In the projector described here, the short-wavelength, that is, blue-emitting pump light source is preferably supplemented by a red-emitting light source. In order to achieve high luminance levels, it is advisable to use red-emitting lasers for this purpose. In principle, however, LEDs can also be used.

Furthermore, it is proposed that the blue and red radiation be guided together via the wavelength conversion element or phosphor element. The phosphor element can be operated in a transmissive arrangement as well as in a reflective arrangement. Due to the high power densities, it is advisable to design the wavelength conversion element as a so-called phosphor wheel, so that the wavelength conversion element is moved and the same area of the wavelength conversion element is not permanently exposed to the pump radiation.

The blue laser radiation is preferably guided out of the beam path in front of the wavelength conversion element via a beam splitter and is led past the wavelength conversion element. If necessary, the beam profile of the blue light is to be adapted, for example, by a scattering element, to the beam profile of the light that has passed the wavelength conversion element, that is, specifically the red light, or is to be adapted to the light that has been generated in the wavelength conversion element by conversion, that is, specifically the green light.

The blue and the red light are preferably guided via the wavelength conversion element. The red light is preferably only scattered, the blue pump radiation is converted into green light. After the wavelength conversion element, there may be another beam splitter for separating the green and red light.

The described setup thus results in three light beams, each of which can be directed to separate imaging units. The imaging units are, for example, LCD elements or LCoS elements, but can also be DLM mirrors, DMD or MEMS mirrors. LCD stands for Liquid Crystal Display and LCoS for Liquid Crystal on Silicon. DLP stands for digital light processing, DMD for digital micro-mirror device and MEMS for micro-optoelectromechanical systems.

Since the blue and red emissions can have different temperature dependencies, it is advantageous to monitor the different colored luminous fluxes, that is, in particular red, green and blue, in the beam path using appropriate sensor technology, such as photodiodes, and if necessary to readjust the light sources accordingly.

The concept described here can be easily integrated into existing projection systems. This concept can be implemented in existing projector architectures with relatively few changes. In addition, improved color reproduction results from further spanning the color space in the red wavelength region and from improved color saturation for the red spectrum. An improvement in spectral efficiency can be achieved by a direct red light source; in contrast, other projectors have higher conversion losses and also scattering losses due to the conversion of blue light into red and green light. Furthermore, improved efficiency results from the elimination of the long-wavelength red tail of the spectrum into the non-visible region, which otherwise occurs when a phosphor is used to generate red and green light. Since the red light is generated by direct emission from a light source, a narrow-band green-emitting phosphor can be used. To achieve good color saturation, spectrally narrow-band emission of each color is desirable. The blue pump source and the red light source are spectrally narrowband. Because the red emission is not generated by conversion, the wavelength conversion element, which emits green light in particular, can be designed to also emit spectrally narrowband light, compared to phosphors that also need to generate red light.

So, in summary, higher projector efficiency and improved color reproduction are possible, with only relatively minor interventions in existing projector architectures.

The projector described herein can be used, for example, in the automotive sector or in aviation, such as for head-up displays. Likewise, the projector described herein can be used for spot lighting, for example, on stages. It is also possible to use it in the field of general lighting.

According to at least one embodiment, the first optoelectronic semiconductor chip comprises or is a first laser diode. The first radiation is preferably blue light. Accordingly, the second optoelectronic semiconductor chip comprises a second laser diode or is a second laser diode and the second radiation is red light. The third radiation is particularly preferably green light.

According to at least one embodiment, the wavelength conversion element is arranged for full conversion of the first portion of the first radiation. That is, all or substantially all of the first radiation reaching the wavelength conversion element is converted to the third radiation.

According to at least one embodiment, the projector further comprises a beam splitter adapted to branch off a second portion of the first radiation even before the wavelength conversion element. In other words, the second portion then does not reach the wavelength conversion element.

According to at least one embodiment, the projector further comprises at least one scattering plate. The scattering plate is located in the beam path of the first radiation, in particular in the beam path of the second portion of the first radiation, and preferably at a point where the first portion is already branched off. This means that only the second portion, but not the first portion, then passes through the scattering plate.

According to at least one embodiment, the second radiation passes through the wavelength conversion element. Thereby, for the second radiation the wavelength conversion element is preferably a passive optical element. In this context, passive means in particular that a direction of at least a part of the second radiation can be changed by the wavelength conversion element, but that the wavelength conversion element has no or no significant influence on a spectral composition and/or intensity of the second radiation. That is, the wavelength conversion element may be a scattering element for the second radiation and is preferably not a wavelength conversion element with respect to the second radiation, but only for the first radiation.

According to at least one embodiment, the projector further comprises a color splitter. For example, the color splitter is located optically downstream of the wavelength conversion element. In particular, the color splitter is adapted to separate the second radiation from the third radiation. For example, the color splitter is a dichroic mirror, such as a Bragg mirror.

According to at least one embodiment, three separate beam paths are provided for the first, second and third beams, at least in some areas. This applies in particular to paths after the color splitter and thus also after the wavelength conversion element.

According to at least one embodiment, the projector further comprises at least one color block. In particular, the color block is located in the beam path of the third radiation, and preferably downstream of the wavelength conversion element. For example, the color block is a dichroic mirror.

According to at least one embodiment, the color block is transparent to the third radiation and opaque to the second radiation. Thus, a separation of the second and the third radiation from each other can be realized by means of the color block.

According to at least one embodiment of the projector, the second radiation is guided past the wavelength conversion element. That is, the second radiation then does not interact with the wavelength conversion element.

According to at least one embodiment of the projector, the wavelength conversion element is arranged for partial conversion of the first radiation. That is, in this embodiment, the entire first radiation and optionally the second radiation may be guided through the wavelength conversion element. Thus, only a portion of the first radiation is converted by the wavelength conversion element, so that a second portion of the first radiation to be emitted by the projector also passes through the wavelength conversion element.

According to at least one embodiment, a common beam path is provided in the projector for the first, the second and the third radiation at least in some areas. That is, the first, the second and the third radiation run in places along the same path within the projector.

According to at least one embodiment, the projector further comprises at least one sensor system. The sensor system is set up to determine intensities of the first radiation and/or the second radiation and/or the third radiation. The sensor system can be used, for example, to compensate for different temperature dependencies of the intensities of the first radiation and the second radiation and optionally of the third radiation. For this purpose, the sensor system comprises, for example, a plurality of photodiodes. The sensor system can be directly or indirectly connected to control electronics for the optoelectronic semiconductor chips and/or to a control element for the wavelength conversion element, such as a cooling unit or a heating unit.

According to at least one embodiment, the wavelength conversion element is operated in transmission. Alternatively, the wavelength conversion element is operated in a reflection mode. If several wavelength conversion elements are present, both operating modes, that is, reflection and transmission, can also be combined.

According to at least one embodiment, a spectral range of the third radiation overlaps with a spectral range of the second radiation immediately after the wavelength conversion element. This means that the third radiation can reach longer wavelengths up to the second radiation.

Alternatively, the third radiation is spectrally spaced from the second radiation immediately after the wavelength conversion element. In other words, the spectra of the second and third radiation then do not overlap at any point within the projector.

According to at least one embodiment, the first radiation and/or the second radiation has a spectral half-width of at most 5 nm or at most 3 nm. The spectral half-width refers in particular to a full width at half the height of a maximum, also referred to as FWHM.

According to at least one embodiment, a spectral half-width of the third radiation immediately after the wavelength conversion element is at least 10 nm or at least 20 nm. Alternatively or additionally, this half-width of the third radiation is at most 100 nm or at most 70 nm or at most 45 nm. In other words, the third radiation is relatively spectrally narrowband.

According to at least one embodiment, wavelengths of maximum intensity lie in the following spectral ranges:
between 445 nm and 475 nm, inclusive, or between 450 nm and 465 nm, inclusive, for the first radiation and/or
between 605 nm and 630 nm, inclusive, or between 615 nm and 625 nm, inclusive, for the second radiation and/or
between 520 nm and 555 nm, inclusive, or between 530 nm and 545 nm, inclusive, for the third radiation.

According to at least one embodiment, the projector is free of moving parts. In particular, the projector does not require a phosphor wheel.

In addition, a projection system comprising a projector as described in connection with one or more of the above embodiments is disclosed. Features of the projection system are therefore also disclosed for the projector and vice versa.

In at least one embodiment, the projection system comprises one or more projectors and at least one imaging unit. In this regard, the projector illuminates the imaging unit. The imaging unit may comprise or be an active element, such as a MEMS or a LCoS, or the imaging unit is a passive element such as a screen or a projection surface.

According to at least one embodiment, the imaging unit is a Liquid Crystal on Silicon element, LCoS, or comprises an LCoS. In particular, in this case, it is possible that the projector is free of any imaging units.

The proposed light source for a projection system, in particular the projector, can therefore operate without moving parts. A so-called phosphor wheel is not required.

The proposed light source provides the three primary colors red, green and blue separately from each other, that is, in pure, separate channels. The light source is thus intended in particular for LCoS imagers than for DLP imagers.

In the following, a projector described herein and a projection system described herein are explained in more detail with reference to the drawing on the basis of exemplary embodiments. The same reference signs indicate identical elements in the individual figures. However, no references to scale are shown, rather individual elements may be shown exaggeratedly large for better understanding.

In the figures:

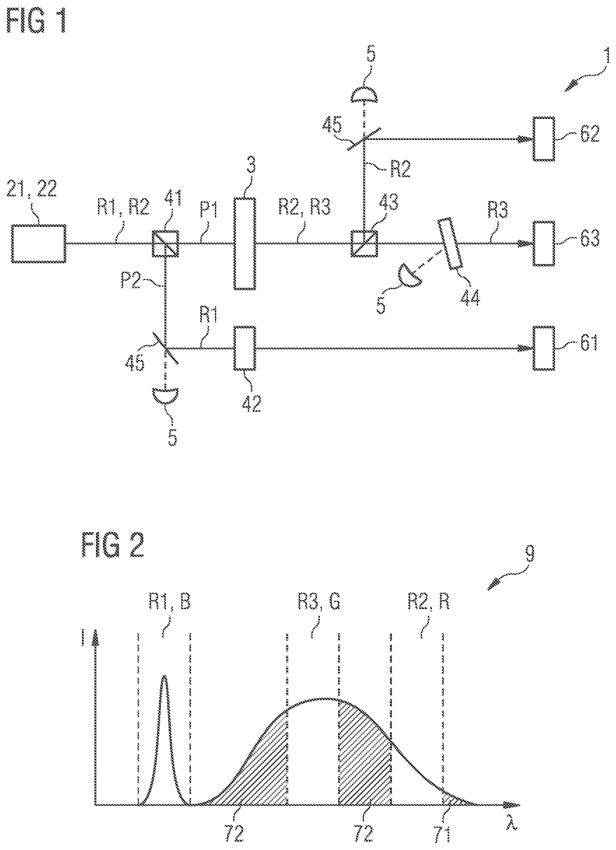

FIG. 1 shows a schematic representation of an embodiment of a projector described herein,

FIG. 2 shows a schematic representation of spectral characteristics of a modification of a projector,

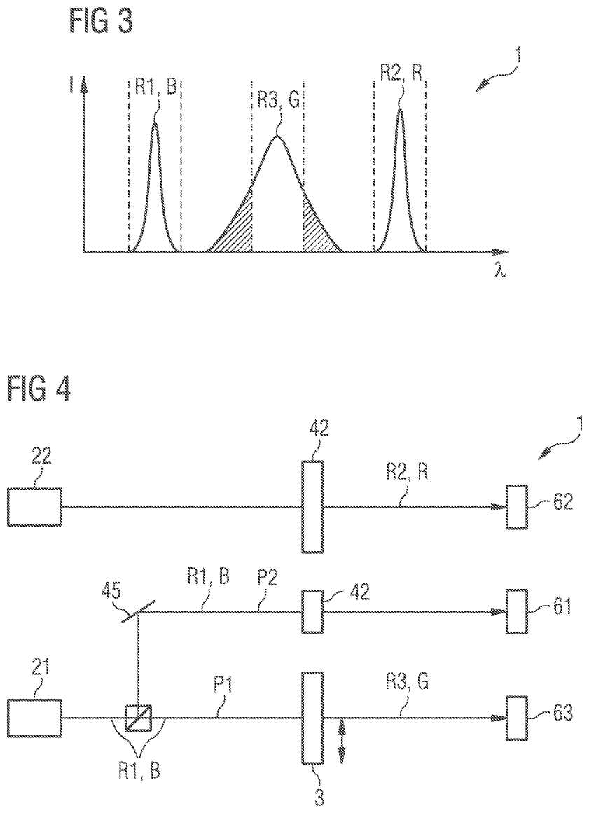

FIG. 3 shows a schematic representation of spectral characteristics of an embodiment of a projector described herein,

FIGS. 4 to 6 show schematic representations of further embodiments of projectors described herein, and

FIG. 7 shows a schematic representation of an embodiment of a projection system with a projector described herein.

In FIG. 1, an embodiment of a projector 1 is schematically shown. The projector 1 comprises as primary light source a first optoelectronic semiconductor chip 21 and a second optoelectronic semiconductor chip 22. The semiconductor chips 21, 22 may be mounted close to each other on a common carrier and share the same optical path towards a beam splitter 41. The semiconductor chips 21, 22 are preferably laser diodes or comprise laser diodes. Here, the first semiconductor chip 21 is configured to generate a first radiation R1 and the second semiconductor chip 22 is configured to generate a second radiation R2. The first radiation R1 is blue light B and the second radiation R2 is red light R.

At the beam splitter 41, the first radiation R1 is split into a first portion P1 and a second portion P2. The second portion P2 is configured to leave the projector 1. The first portion P1 reaches a wavelength conversion element 3 and is converted as completely as possible into a third radiation R3. The third radiation is preferably spectrally comparatively narrow-band green light G. That is, after the wavelength conversion element 3, blue light is preferably no longer present in the corresponding beam path. The second radiation R2 preferably passes through the wavelength conversion element 3 without any wavelength conversion.

After the wavelength conversion element 3, there is preferably a color splitter 43, which is traversed, for example, by the third radiation R3 and at which the second radiation R2 is reflected. In the further beam path of the third radiation R3, there may optionally be a color block 44 which is opaque to the second radiation R2. Furthermore, the color block 44 may at the same time be opaque to any small residuals of the first radiation R1.

Thus, after the color block 44, the color splitter 43 and the beam splitter 41, three different beam paths are present for the first, second and third radiations R1, R2, R3. To ensure that all beams R1, R2, R3 have the same properties with regard to divergence of the respective radiation, a scattering plate 42 can be located in the beam path of the second portion P2. The scattering plate 42 can cause the same divergence in the second portion 42 as is caused by the wavelength conversion element 3 for the second radiation R2 and the third radiation R3.

Optionally, the projector 1 comprises imaging units 61, 62, 63, in particular at ends of the three separate beam paths for the red, green and blue light. The imaging units 61, 62, 63 are, for example, LCD masks. Alternatively, however, it is equally possible that such imaging units are only present outside the projector 1.

In the projector 1 described here, therefore, only the green light G is generated by means of the wavelength conversion element 3 and not the red light R, for which a separate light source is provided in the form of the second optoelectronic semiconductor chip 22. The associated improved efficiency and improved spectral characteristics are explained in more detail in connection with FIGS. 2 and 3.

Optionally, the projector 1 has a sensor system 5 comprising, for example, several photodiodes. Thus, an intensity measurement can be made for each of the radiations R1, R2, R3, or at least for the first and second radiations R1, R2. Via control electronics, not drawn, the intensities of the radiations R1, R2, R3 can then be matched to each other in order to be able to ensure a color reproduction quality that is constant over time. For example, the first and second radiation R1, R2 are detected by directing a portion of the radiation passing through a Bragg mirror 45 to a photodiode, or in the case of the third radiation R3, a reflection from the color block 44 is used for intensity measurement.

FIG. 2 shows a situation that occurs in a modification 9 of a projector: There is only one semiconductor chip for generating blue light B, and the red light R and the green light G are generated by a phosphor. Therefore, the phosphor must have a broad emission spectrum, ranging from the green spectral region to well into the red spectral region. Filters, which are necessary to define the individual spectral ranges B, R, G, thus cut away a relatively large part of the light generated by the phosphor.

This results in efficiency losses 71, especially in the red spectral range, towards longer wavelengths than specified by the usable red spectral range R. In addition, since the green spectral range is fully utilized and the green light G thus has a large spectral width, gamut losses 72 also result, especially due to the fact that the green light G has an almost constant intensity in the allowed spectral range.

In contrast, in the projector 1 described here, the wavelength conversion element 3 can be selected so that a spectrally narrow-band emission in the green spectral range G is sufficient and no emission in the red spectral range is required, see FIG. 3. In addition, the third radiation R3 can have a pronounced maximum in the green spectral range G so that a larger gamut can be displayed.

For example, the spectral widths of the first and second radiations R1, R2 are at 2 nm and the spectral width of the third radiation R3 is between 10 nm and 30 nm, inclusive.

Deviating from the illustration in FIG. 3, it is also possible that the emission spectrum of the wavelength conversion element 3 extends from the green spectral range G into the red spectral range R, although this is not decisive for the function of the projector 1.

FIG. 4 illustrates another embodiment of the projector 1. Here, the second optoelectronic semiconductor chip 22 is mounted optically separate from the first optoelectronic semiconductor chip 21, so that the first radiation R1 and the second radiation R2 can have completely separate beam paths. As in the beam path of the second portion P2 of the first radiation R1, there may optionally be a scattering plate 42 in the beam path of the second radiation R2 to simulate the scattering characteristics of the wavelength conversion element 3.

In addition, as a further option, it is shown in FIG. 4 that the wavelength conversion element 3 can be movably mounted, symbolized by a double arrow. This means that the wavelength conversion element 3 can be a so-called rotating phosphor wheel, or the wavelength conversion element 3 is a small plate that is constantly displaced. By having a movable wavelength conversion element 3, photochemical and/or thermal stress on a phosphor can be reduced because the same location of the wavelength conversion element 3 is not permanently exposed to the first radiation R1. By moving the wavelength conversion element 3, preferably its conversion characteristics do not change or do not change significantly. Such a movable wavelength conversion element 3 may also be present in all other embodiments.

In all other respects, the comments on FIGS. 1 to 3 apply in the same way to FIG. 4, and vice versa.

In the example shown in FIG. 5, it is illustrated that the first, second and third beams R1, R2, R3 can occupy the same beam path in certain areas, for example, until after the wavelength conversion element 3. An optional beam splitting via color splitter 43 can be connected downstream.

In all other respects, the comments on FIGS. 1 to 4 apply in the same way to FIG. 5, and vice versa.

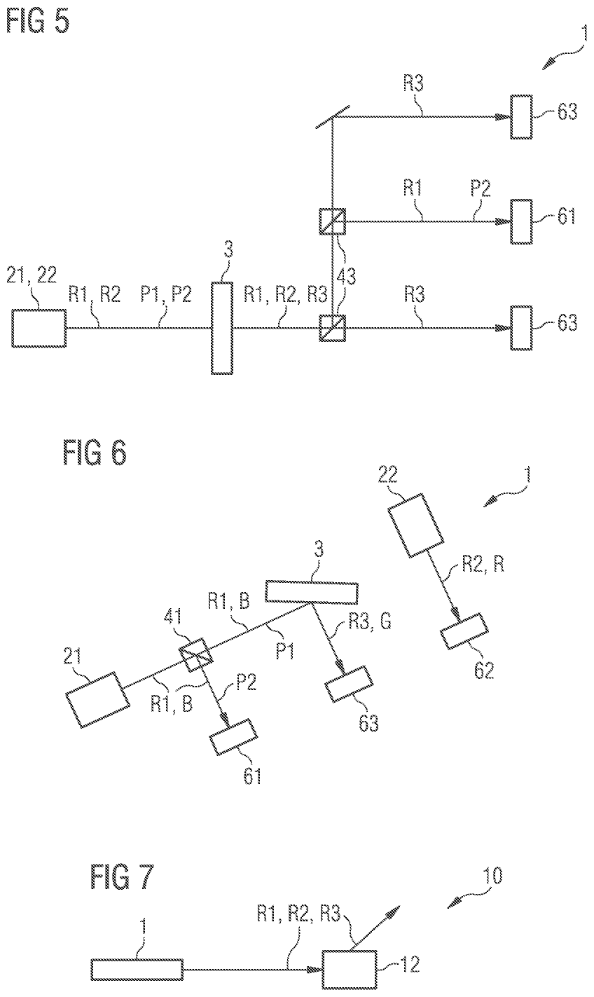

According to FIG. 6, the wavelength conversion element 3 is operated in reflection, and not in transmission, as in the exemplary embodiments of FIGS. 1, 4 and 5. Here, the principle beam path corresponds to the exemplary embodiment of FIG. 4, whereby the optional scattering plates are not drawn in FIG. 6. In the same way, such a wavelength conversion element 3 operated in reflection can be used in the exemplary embodiments of FIGS. 1 and 5.

In all other respects, the comments on FIGS. 1 to 5 apply in the same way to FIG. 6, and vice versa.

FIG. 7 illustrates an embodiment of a projection system 10. The projection system 10 comprises at least one projector 1, as explained, for example, in connection with FIG. 1, 4, 5 or 6. An imaging unit 12 is illuminated by the projector 1. In this context, the imaging unit 12 may be an active element, such as a MEMS or a LCoS, so that the projector 1 may be free of imaging units 61, 62, 63. Alternatively, the imaging unit 12 is a passive element, such as a screen or a projection surface.

In all other respects, the comments on FIGS. 1 to 6 apply in the same way to FIG. 7, and vice versa.

The invention described herein is not limited by the description based on the embodiments. Rather, the invention encompasses any new feature as well as any combination of features, which in particular includes any combination of features in the patent claims, even if this feature or combination itself is not explicitly stated in the patent claims or embodiments.

This patent application claims the priority of German patent application 10 2021 109 640.5, the disclosure content of which is hereby incorporated by reference.

### LIST OF REFERENCE SIGNS

1 projector
21 first optoelectronic semiconductor chip
22 second optoelectronic semiconductor chip
3 wavelength conversion element
41 beam splitter
42 scattering plate
43 color splitter
44 color block
45 mirror
5 sensor system
61 imaging unit for blue light
62 imaging unit for red light
63 imaging unit for green light
71 efficiency loss
72 gamut loss
9 modification of a projector
10 projection system
12 imaging unit
I intensity
P1 first portion of the first radiation
P2 second portion of the first radiation
R1 first radiation (blue; B)
R2 second radiation (red; R)
R3 third radiation (green; G)
λ wavelength

1. A projector comprising
a first optoelectronic semiconductor chip for generating a first radiation having a first color,
a second optoelectronic semiconductor chip for generating a second radiation having a second color,
a wavelength conversion element which is configured to generate a third radiation having a third color from a first portion of the first radiation,
a beam splitter, and
a scattering plate,
wherein
the wavelength conversion element is configured to fully convert the first portion of the first radiation,
the beam splitter is configured to branch off a second portion of the first radiation upstream of the wavelength conversion element, and
the scattering plate is arranged in a beam path of the second portion of the first radiation at a point at which the first portion has already been branched off.

2. The projector according to claim 1,
wherein
the first optoelectronic semiconductor chip comprises a first laser diode and the first radiation is blue light,
the second optoelectronic semiconductor chip comprises a second laser diode and the second radiation is red light, and
the third radiation is green light.

3. The projector according to claim 1, wherein the second radiation passes through the wavelength conversion element, wherein the wavelength conversion element is a passive optical element for the second radiation.

4. The projector according to claim 3, further comprising a color splitter downstream of the wavelength conversion element, wherein the color splitter is configured to separate the second radiation from the third radiation so that three separate beam paths are provided for the first radiation, the second radiation and the third radiation at least partially.

5. The projector according to claim 1, further comprising a color block in the optical path of the third radiation downstream of the wavelength conversion element,
wherein the color block is transmissive to the third radiation and opaque to the second radiation.

6. The projector of claim 1,
wherein the second radiation is directed past the wavelength conversion element such that the second radiation does not interact with the wavelength conversion element.

7. The projector according to claim 1, further comprising a sensor system configured to determine intensities of the first radiation and the second radiation such that different temperature dependencies of the intensities of the first radiation and the second radiation can be compensated.

8. The projector according to claim 1, wherein the wavelength conversion element is operated in transmission.

9. The projector of claim 1,
wherein the wavelength conversion element is operated in reflection.

10. The projector according to claim 1, wherein a spectral range of the third radiation overlaps with a spectral range of the second radiation immediately after the wavelength conversion element.

11. The projector according to claim 1, wherein the first radiation and the second radiation each have a spectral half-width of at most 5 nm, and a spectral half-width of the third radiation immediately after the wavelength conversion element is between 10 nm and 100 nm, inclusive,
wherein wavelengths of maximum intensity of the first radiation, the second radiation and the third radiation are located in the following spectral ranges:
between 445 nm and 475 nm inclusive for the first radiation,
between 605 nm and 630 nm inclusive for the second radiation, and
between 520 nm and 555 nm inclusive for the third radiation.

12. The projector according to claim 1, which is free of moving parts.

13. A projector comprising
a first optoelectronic semiconductor chip for generating a first radiation having a first color,
a second optoelectronic semiconductor chip for generating a second radiation having a second color,
a wavelength conversion element arranged to generate a third radiation having a third color from a first portion of the first radiation,
wherein the wavelength conversion element is configured for a partial conversion of the first radiation, the entire first radiation and the second radiation being guided through the wavelength conversion element, so that a common beam path is provided for the first radiation, the second radiation and the third radiation, at least in places.

14. A projection system comprising
a projector according to claim 1, and
an imaging unit,
wherein the projector illuminates the imaging unit.

15. The projection system according to claim 14, wherein the imaging unit comprises or is a Liquid Crystal on Silicon element, LCoS, and wherein the projector is free of imaging units.
